(19) United States
(12) Patent Application Publication
(10) Pub. No.: US 2018/0164569 A1
(43) Pub. Date: Jun. 14, 2018

(54) MICROPLATE AND MICROSCOPE SYSTEM

(71) Applicant: OLYMPUS CORPORATION, Tokyo (JP)

(72) Inventors: Brendan BRINKMAN, Hopkinton, MA (US); Yoshihiro SHIMADA, Kanagawa (JP)

(73) Assignee: OLYMPUS CORPORATION, Tokyo (JP)

(21) Appl. No.: 15/828,980

(22) Filed: Dec. 1, 2017

(30) Foreign Application Priority Data
Dec. 8, 2016 (JP) 2016-238447

(51) Int. Cl. G02B 21/34; G02B 21/26; G02B 21/06; G02B 21/36; G02B 27/30; G02B 21/16; G01N 21/64

(52) U.S. Cl. CPC G02B 21/34; G02B 21/26; G02B 21/06; G02B 21/361; G01N 2021/6478; G02B 21/16; G01N 21/6452; G01N 21/6458; G02B 27/30

(57) ABSTRACT

This microplate includes: container sections having wells that open at a first plane and that accommodate samples; and a connection section connecting a plurality of rows of the container sections to be arrayed in a manner where the rows are spaced from each other in a direction along the first plane, wherein each of the container sections includes: at least one side wall section that is optically transparent at at least a portion thereof; and a bottom surface section that is disposed on a second plane on a side opposite from the first plane and that is optically transparent at at least a portion thereof, a recessed section is provided between neighboring rows of the container sections, and the recessed section allows an optical member to be inserted thereinto via the second plane, wherein the optical member introduces sheet-shaped illumination light to the well via the side wall section.

### CROSS-REFERENCE TO RELATED APPLICATIONS

This application is based on and claims priority to Japanese Patent Application No. 2016-238447 filed on Dec. 8, 2016, the entire content of which is incorporated herein by reference.

### TECHNICAL FIELD

The present invention relates to a microplate and a microscope system.

### BACKGROUND ART

There is a well known light-sheet microscope that can acquire images of a plurality of samples successively in order to enhance the throughput for image acquisition in a case where the images are used in drug development screening or in vitro diagnosis (refer to, for example, PTL 1).

In this light-sheet microscope, a deflector for introducing sheet-shaped illumination light and an objective lens for collecting fluorescence generated in the samples are inserted, from above, into a container that has an opening at the top and that accommodates a plurality of samples.

### CITATION LIST

### Patent Literature

### {PTL 1}

U.S. Unexamined Patent Application Publication No. 2016/153892

### SUMMARY OF INVENTION

An aspect of the present invention provides a microplate including: a plurality of container sections having wells that open at a first plane and that accommodate samples; and a connection section connecting a plurality of rows of the container sections so as to be arrayed in a manner in which the rows are spaced from each other in a direction along the first plane, wherein each of the container sections includes: at least one side wall section that is optically transparent at at least a portion thereof; and a bottom surface section that is disposed on a second plane on a side opposite from the first plane and that is optically transparent at at least a portion thereof, and wherein a recessed section is formed between neighboring rows of the container sections, and the recessed section allows an optical member to be inserted thereinto crossing the second plane, wherein the said optical member introduces sheet-shaped illumination light into the well via the side wall section in a direction substantially parallel to the first plane.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; two of the optical members that are inserted from a lower side into the recessed sections formed between the neighboring rows of the container sections of the microplate, that introduce illumination light from light sources and from a lower side of the microplate, and that bend the illumination light to enter the well via the two side wall sections as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens, and wherein the movable stage rotates the microplate about the axial line.

### BRIEF DESCRIPTION OF DRAWINGS

FIG. 1 is a partial longitudinal sectional view showing a microscope system according to an embodiment of the present invention.

FIG. 2 is a schematic plan view showing the microscope system in FIG. 1.

FIG. 3 is a plan view showing a microplate according to an embodiment of the present invention.

FIG. 4 is a bottom view of the microplate in FIG. 3.

FIG. 5 is a longitudinal sectional view of the microplate in FIG. 3.

FIG. 6 is a partial longitudinal sectional view showing a first modification of the microscope system in FIG. 1.

FIG. 7 is a schematic plan view showing a second modification of the microscope system in FIG. 1.

FIG. 8 is a schematic diagram showing a modification of an optical member of the microscope system in FIG. 1.

FIG. 9 is a plan view showing a third modification of the microscope system in FIG. 1.

FIG. 10 is a partial longitudinal sectional view of the microscope system in FIG. 9.

FIG. 11 is an exploded perspective view showing a first modification of the microplate in FIG. 3.

FIG. 12 is a longitudinal sectional view showing a modification of the microplate in FIG. 11.

FIG. 13 is an exploded perspective view showing a second modification of the microplate in FIG. 3.

FIG. 14 is a perspective view showing a third modification of the microplate in FIG. 3.

FIG. 15 is a partial longitudinal sectional view showing the microplate in FIG. 14.

FIG. 16 is an exploded perspective view showing a fourth modification of the microplate in FIG. 3.

FIG. 17 is a side view showing a fifth modification of the microplate in FIG. 3.

FIG. 18 is a longitudinal sectional view showing a sixth modification of the microplate in FIG. 3.

FIG. 19 is a plan view showing the microplate in FIG. 18.

FIG. 20 is a plan view showing a modification of the microplate in FIG. 18.

FIG. 21 is a partial longitudinal sectional view showing a fourth modification of the microscope system in FIG. 1.

FIG. 22 is a plan view showing another modification of the microplate in FIG. 3.

FIG. 23 is a plan view showing another modification of the microplate in FIG. 3.

### DESCRIPTION OF EMBODIMENTS

A microscope system 1 and a microplate 2 according to an embodiment of the present invention will now be described with reference to the drawings.

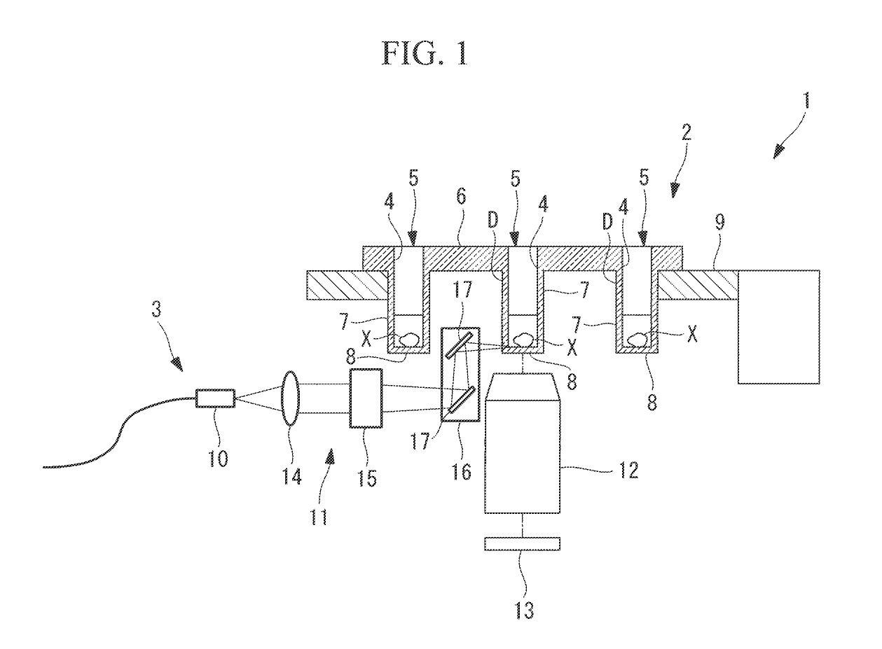

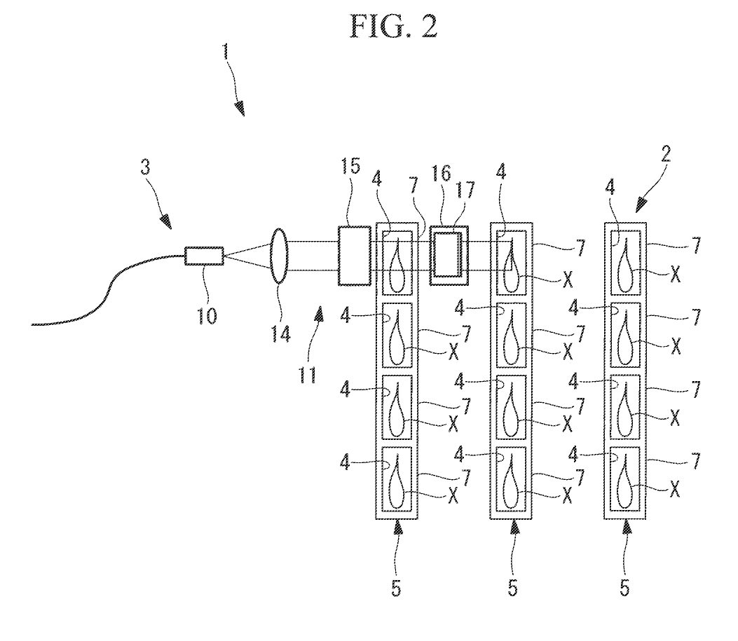

As shown in FIGS. 1 and 2, the microscope system 1 according to this embodiment includes the microplate 2 according to this embodiment and a microscope 3 for performing observation in a state where this microplate 2 is mounted.

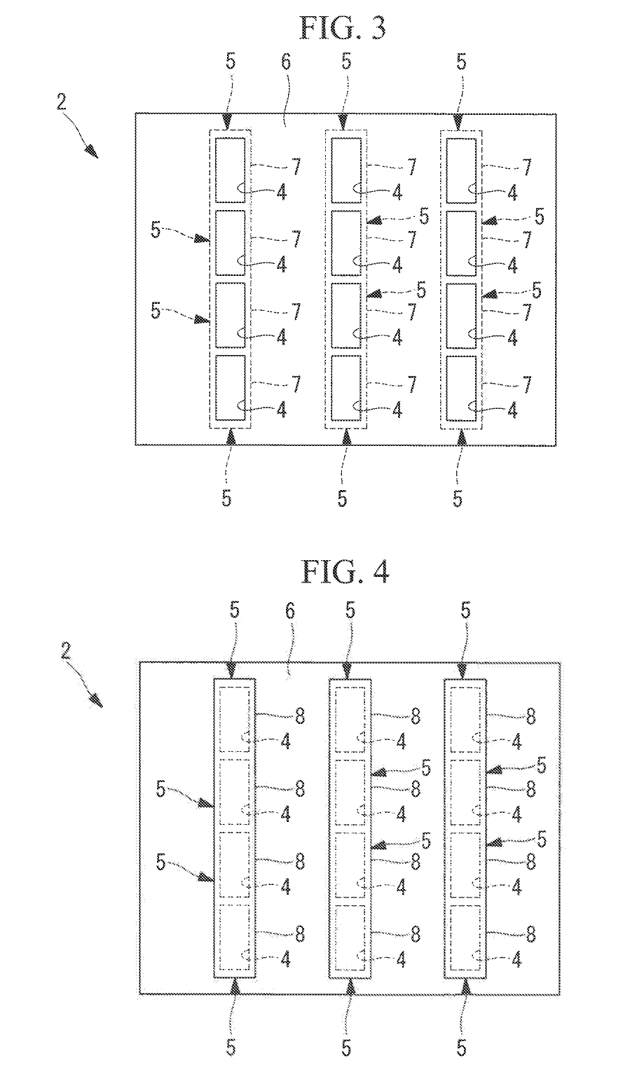

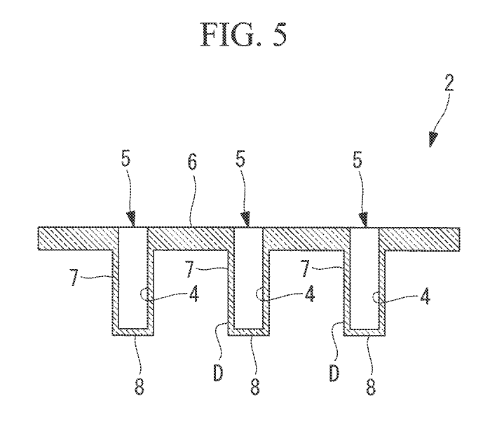

As shown in FIGS. 1 to 5, the microplate 2 according to this embodiment includes: three rows of container sections 5, each row of the container section 5 having four wells 4 that open, for example, toward one direction (first plane); and a flat-plate-shaped connection section 6 for connecting the surroundings of the openings of these container sections 5. Each of the container sections 5 includes a side wall section 7 and a bottom surface section 8 each of which has an optically transparent region in at least a portion thereof. As shown in FIGS. 1 and 5, a recessed section D that is recessed from the bottom surface section (second plane) 8 towards the connection section 6 is provided between the rows of the container sections 5.

In this embodiment, each row of the container sections 5 has the common planar side wall section 7 extending in a direction orthogonal to the connection section 6. In addition, the bottom surface sections 8 are disposed orthogonal to the side wall section 7. With this configuration, when the connection section 6 is disposed substantially horizontally with the openings in the wells 4 oriented upward, the side wall sections 7 of the container sections 5 are disposed in a plane extending in a substantially vertical direction, and the bottom surface sections 8 are disposed so as to extend in a substantially horizontal direction.

As shown in FIG. 1, the microscope 3 includes: a movable stage 9 for mounting the microplate 2 with the openings oriented upward; an illumination optical system 11 for irradiating a sample X in a well 4 with excitation light (illumination light) coming from a light source 10; an objective lens 12 for collecting, vertically below the bottom surface section 8, the fluorescence (light) coming from the sample X; and an image acquisition element (image acquisition unit) 13 for acquiring an image of the light collected by this objective lens 12.

The movable stage 9 is configured to be capable of moving the mounted microplate 2 three-dimensionally.

The illumination optical system 11 includes: a collimator lens 14 for converting excitation light coming from the light source 10 into substantially collimated light; a cylindrical lens 15 for focusing the excitation light converted into collimated light in one direction; an optical member 16 that bends, through deflection, the sheet-shaped excitation light focused by this cylindrical lens 15 and introduces the sheet-shaped excitation light to the well 4 via the side wall section 7 of a container section 5.

The optical member 16 includes two mirrors 17 each of which deflects the excitation light by substantial 90°. The horizontal position of the optical member 16 relative to the objective lens 12 is set so that the focal position of the sheet-shaped excitation light intersects the optical axis of the objective lens 12.

The objective lens 12 includes a focusing mechanism, which is not shown in the figure, for moving this objective lens 12 up/down along the optical axis thereof.

The image acquisition element 13 is a two-dimensional sensor, such as a CCD or a CMOS imaging device.

As shown in FIG. 1, the optical member 16 is inserted vertically from the lower side into a recessed section D formed on the bottom surface section 8 side of the microplate 2. Therefore, the optical member 16 and the recessed section D are configured to have sizes that allow the optical member 16 to be inserted up to a position where the sheet-shaped excitation light can be made incident on the focal position of the objective lens 12, even in a state where the focal position of the objective lens 12 is disposed at the uppermost position, more specifically, even in a state where an optical element at the distal end of the objective lens 12 is disposed at a position where the optical element comes into contact with the bottom surface of the microplate 2.

The operation of the microscope system 1 according to this embodiment with the above-described structure will be described below.

In order to observe samples X using the microscope system 1 according to this embodiment, a predetermined medium is stored in each of the wells 4, and then the microplate 2 accommodating the samples X immersed in these media is placed on the movable stage 9.

Subsequently, the microplate 2 is moved by operating the movable stage 9 so that the objective lens 12 is disposed vertically below the bottom surface section 8 of the container section 5 accommodating the sample X to be observed. By doing so, the objective lens 12 is disposed in a manner spaced apart from, and vertically below, the bottom surface section 8 of one of the container sections 5 of the microplate 2, and the optical member 16 is disposed such that the top end thereof is inserted in the recessed section D formed in the lower part of the microplate 2.

When the light source 10 emits excitation light in the horizontal direction in this state, the excitation light emitted from the light source 10 is converted by the collimator lens 14 into substantially collimated light and is then focused by the cylindrical lens 15 in one direction, thus generating sheet-shaped excitation light in which the thickness of the light beam is reduced gradually to the focal position. The sheet-shaped excitation light is bent in a crank manner by the two mirrors 17 of the optical member 16, passes through the side wall section 7 of the container section 5, and is then incident upon the sample X in the well 4.

Since its focal position is located in the sample X in the well 4, the sheet-shaped excitation light is radiated onto a thin region along a plane horizontally intersecting the sample X, which generates fluorescence in the irradiated region. Part of the generated fluorescence goes downward through the bottom surface section 8 of the container section 5, is collected by the objective lens 12 disposed below the bottom surface section 8, and is then imaged by the image acquisition element 13. By doing so, a fluorescence image of the sample X along a plane extending in the focal plane of the objective lens 12 can be acquired.

Thereafter, when the sample X is to be observed at a different position in the optical-axis direction of the objective lens 12, the focal plane in the sample X can be changed by moving the movable stage 9 up/down, without changing the relationship between the focal position of the objective lens 12 and the plane position at which the sheet-shaped excitation light is disposed. By doing so, image information of the sample X can be acquired in a three-dimensional manner. The focusing mechanism of the objective lens 12 can be used and operated for adjustment purposes in a case where the focal plane of the objective lens 12 and the plane in which the excitation light is disposed are shifted.

In addition, also when the sample X in the well 4 of a container section 5 disposed in a different row of the microplate 2 is to be observed, observation can be performed easily by operating the movable stage 9 to change the bottom surface section 8 facing the objective lens 12 and the recessed section D in which the optical member 16 is inserted.

In this case, the microscope system 1 according to this embodiment affords an advantage in that, because the optical member 16 is inserted from the lower side into a recessed section D formed between the rows of the container sections 5, and sheet-shaped excitation light is made incident upon a sample X by causing the excitation light to pass through the transparent portion of the side wall section 7, the sample X can be reliably irradiated with the sheet-shaped excitation light even if the sample X is disposed in the vicinity of the bottom surface section 8 in the well 4. In other words, because the optical member 16, unlike the conventional way, is not inserted from above into a container section accommodating a sample X, the problem that the sample X cannot be observed at a position near the bottom surface due to interference between the optical member 16 and the bottom surface does not occur. Note that the index of refraction of the bottom surface section 8 and the index of refraction of the medium in the well 4 are preferably identical to each other in order to prevent part of the excitation light from refracting at the bottom surface section 8. In addition, it is more preferable that the bottom surface section 8 be manufactured such that the index of refraction of the material of the bottom surface section 8 is adjusted to the index of refraction of the medium assumed to be used.

In addition, according to the microscope system 1 of this embodiment, the samples X accommodated in the four wells 4 arrayed in one row can be successively observed merely by moving the movable stage 9 along the horizontal direction in which the wells 4 are arrayed. In this case, an advantage is afforded in that because the optical member 16 does not come into contact with the media in the wells 4, observation can be efficiently performed while preventing the occurrence of contamination between different wells 4 and a change in the state of the sample X resulting from each of the media being agitated.

In addition, according to the microplate 2 of this embodiment, because the side wall section 7 of each of the container sections 5 is configured to extend in a substantially vertical direction, the refraction, at the side wall section 7, of sheet-shaped illumination light introduced in the horizontal direction is reduced, thereby allowing the sheet-shaped illumination light to be incident upon the focal plane of the objective lens 12 more simply and more accurately. By doing so, a sharp image can be easily acquired by minimizing the burden involved with focal position alignment work using the focusing mechanism.

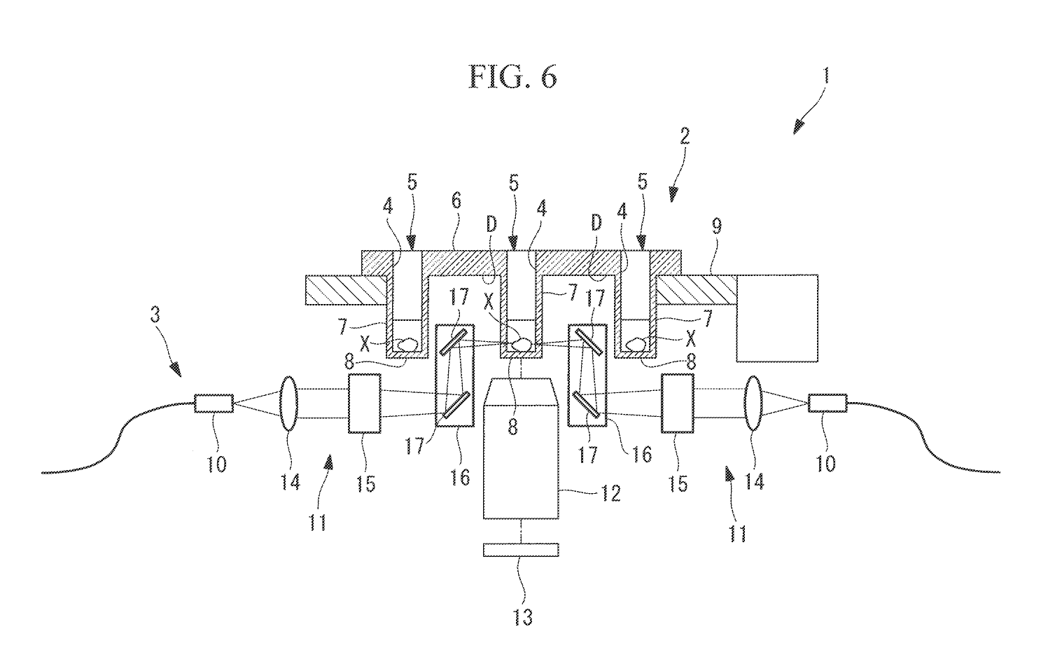

In the microscope system 1 according to this embodiment, two of the side wall sections 7 facing each other with the well 4 interposed therebetween may be provided with optically transparent portions in each of the container sections 5, thereby allowing the sample X in one container section 5 to be irradiated with sheet-shaped excitation light via the two side wall sections 7 in two directions, as shown in FIG. 6. Because excitation light introduced only in one direction attenuates in a sample X if the sample X is large, this configuration is advantageous in that the entire sample X can be uniformly irradiated with excitation light by introducing the excitation light in another direction.

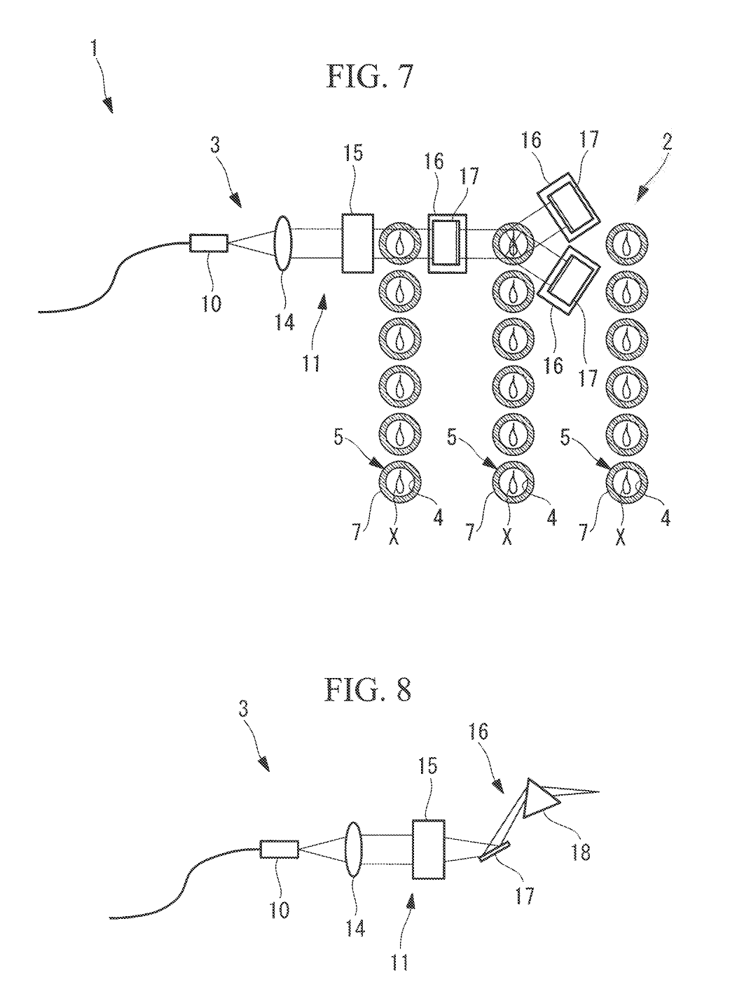

This embodiment has been described by way of an example where the container section 5 in each of the rows has the planar, common side wall section 7. Instead of this, this embodiment may be configured so that the container sections 5 have individual cylindrical side wall sections 7, as shown in FIG. 7. In this case, the number of directions in which sheet-shaped excitation light is introduced is not limited to two but may be three or more, as shown in FIG. 7.

This embodiment has been described by way of an example of the optical member 16 having two mirrors 17. Instead of this, the optical member 16 having a mirror 17 and a prism 18 or two prisms 18 may be employed, as shown in FIG. 8. In addition, if an optical member 16 composed of the mirror 17 and the prism 18 is employed and the excitation light is bent at an angle of less than 90° by adjusting the angles of the mirror 17 and the prism 18, not only can the height dimension of the optical member 16 be decreased but also sheet-shaped excitation light can be formed in the vicinity of the top end thereof. This allows a smaller depth for each of the recessed sections D.

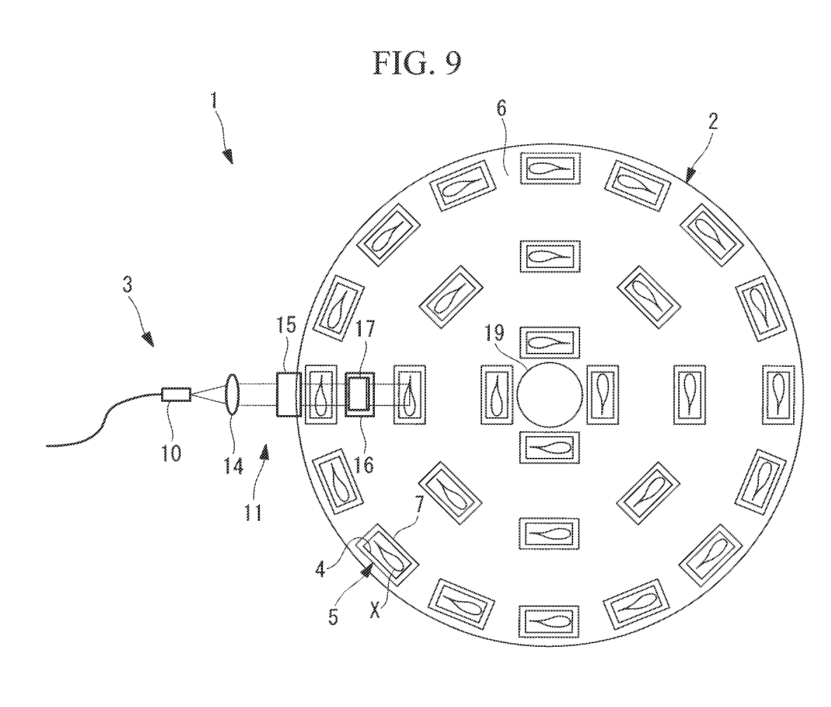

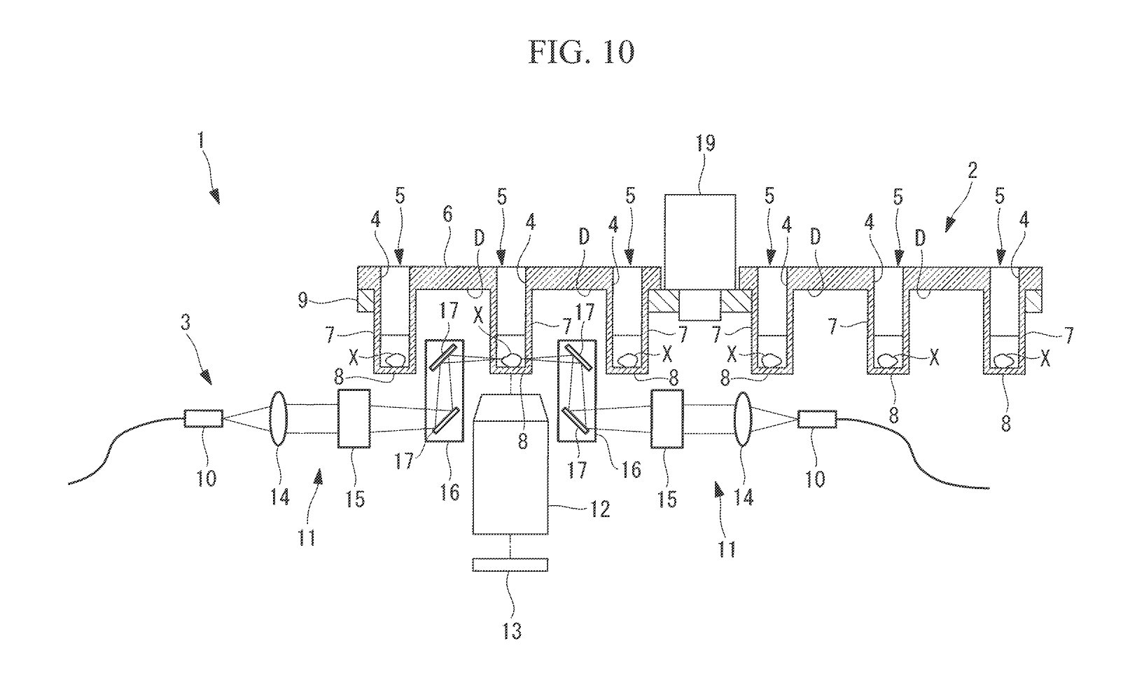

This embodiment has been described by way of an example of the microplate 2 in which the wells 4 are arrayed in a linear shape. Instead of this, as shown in FIGS. 9 and 10, a microplate 2 having a plurality of wells 4 that are arrayed in a ring shape about the central axis and that are also arranged in a plurality of rows in a manner where the rows are spaced from each other in the radial direction may be employed.

In this case, the movable stage 9 may be provided with a motor 19 for rotating the microplate 2 about the central axis of the array of the wells 4.

By doing so, once the optical member 16 and the objective lens 12 have been positioned relative to the microplate 2 mounted on the movable stage 9, the samples X in the neighboring wells 4 in the same row can be observed in sequence by rotating the microplate 2 about the central axis through the operation of the motor 19.

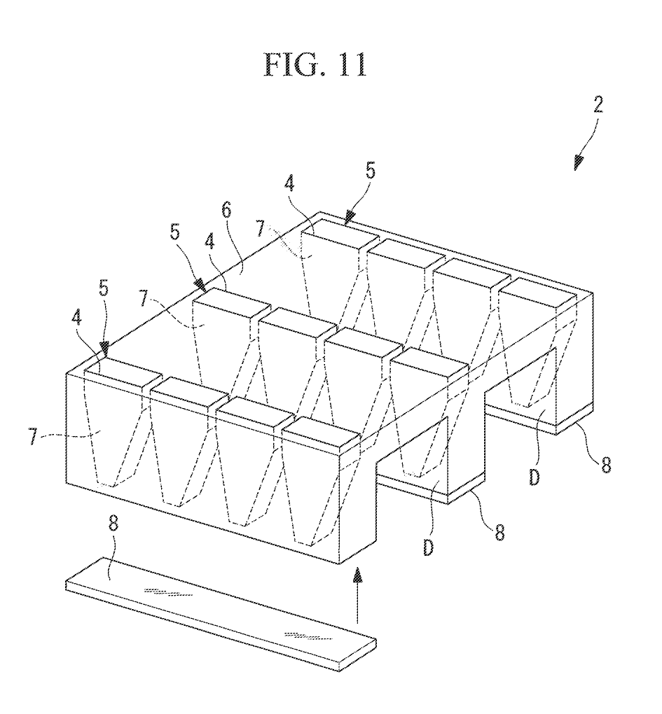

In addition, in this embodiment, the frame constituting the connection section 6 and the side wall sections 7 may be formed through resin injection molding, and only the bottom surface sections 8 may be formed of glass plates or a resin film, and then the frame and the bottom surface section 8 may be adhered or fixed through thermal bonding, as shown in FIG. 11. This affords an advantage in that images with sufficient resolution can be acquired by preventing image deterioration even using an objective lens 12 with high planeness accuracy and high resolution.

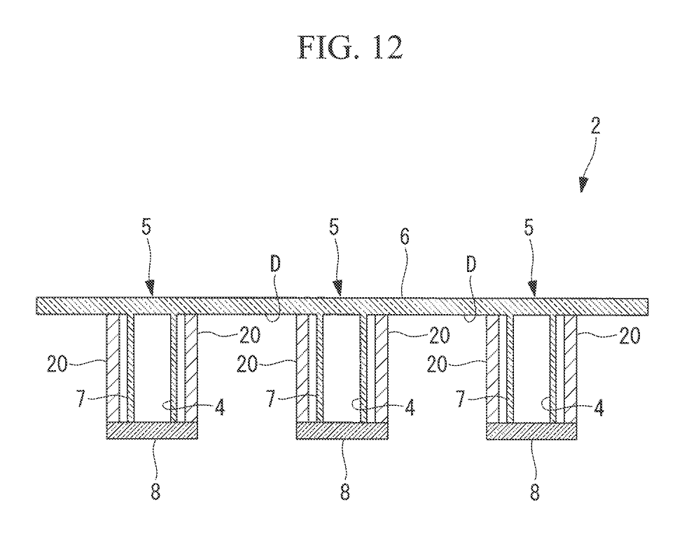

In this case, a support member 20 for supporting the glass plate of each of the bottom surface sections 8 may be provided on the frame side, as shown in FIG. 12.

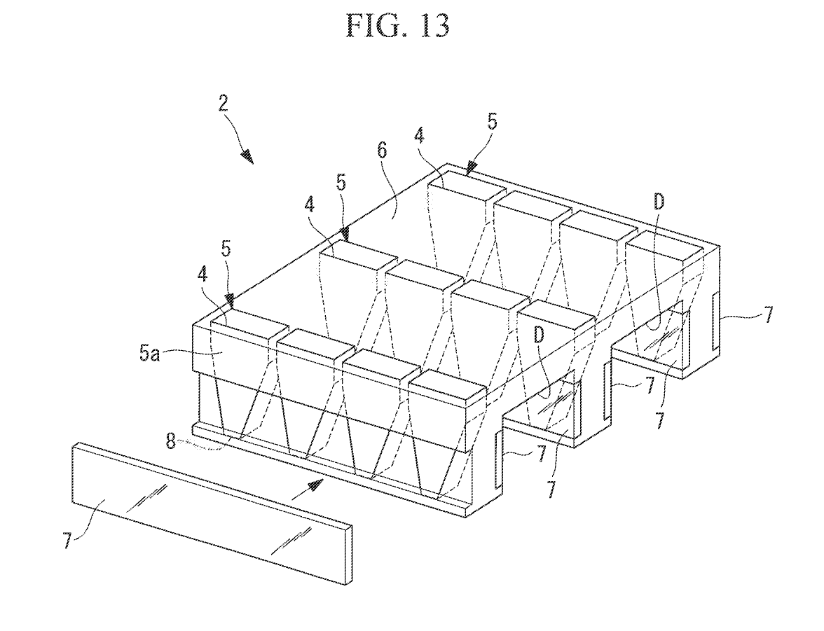

In addition, as shown in FIG. 13, a frame 5a, which excludes the portions of the side wall sections 7 made to transmit sheet-shaped excitation light, may be formed through resin injection molding, only the side wall sections 7 may be formed of glass plates or a resin film, and then the frame 5a and the side wall sections 7 may be adhered or fixed through thermal bonding.

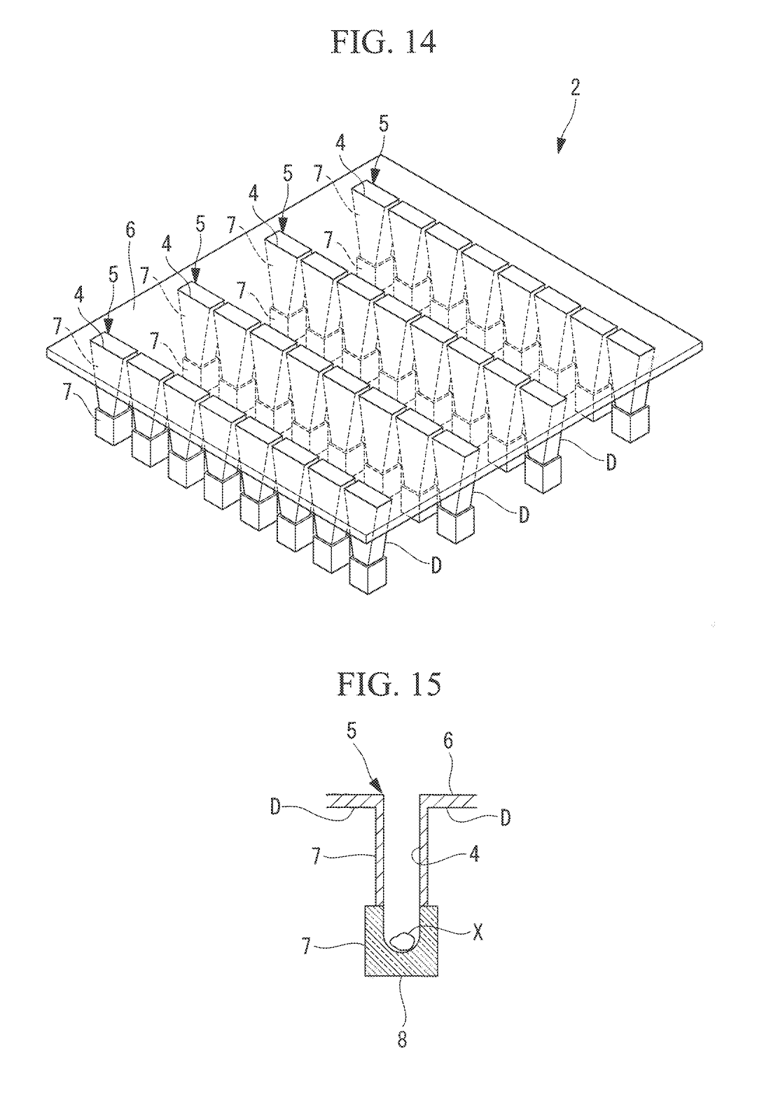

In addition, as shown in FIGS. 14 and 15, the microplate 2 may be manufactured such that a portion of each of the side wall sections 7, which transmits excitation light, and the bottom surface section 8, which transmits fluorescence, may be integrally formed of a resin material with high optical performance and the part is then bonded to the remaining portions. In this case, a resin material with high optical performance may be employed only for the portions of the side wall sections 7 and for the bottom surface sections 8, so that a less expensive material may be employed for the remaining portions, thereby reducing the cost.

In addition, the inner shape of each of the bottom surface sections 8 may be, for example, hemispheric, and the interior may be subjected to non-cellular adhesive surface treatment. By doing so, a cell culture environment suitable for formation of a spheroid through cell culture can be provided. In contrast, a culture environment suitable for forming a cell sheet, in which cells are layered in a sheet shape, can be provided by forming the inner shape of a bottom surface section 8 to be planar and then applying cell adhesive surface treatment. The above-described variations can be set depending on the purpose. For example, variations with different inner shapes and different surface treatment may be connected to the connection section 6. In addition, with these variations, for example, the configuration of the microplate with a barcode added to the top surface of the connection section 6 can be recognized. Furthermore, the configuration may be changed freely by employing a set-in method, instead of a bonding method, for connection.

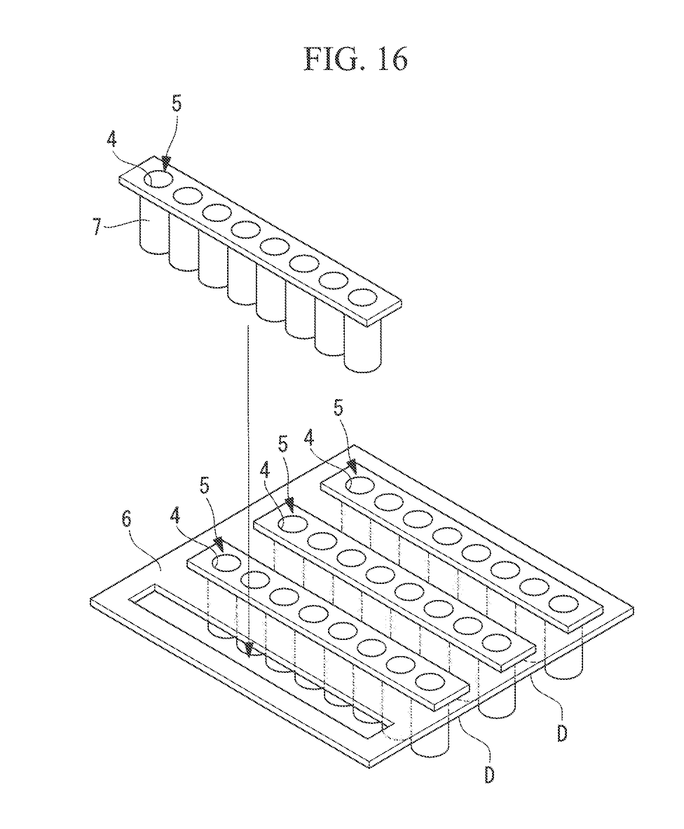

In addition, as shown in, FIG. 16, the connection section 6 and the container sections 5 may be configured of different members and may be combined with each other to constitute the microplate 2. Even in this case, a resin material with high optical performance may be employed for the container sections 5, and a less expensive material may be employed for the connection section 6, thereby reducing the cost.

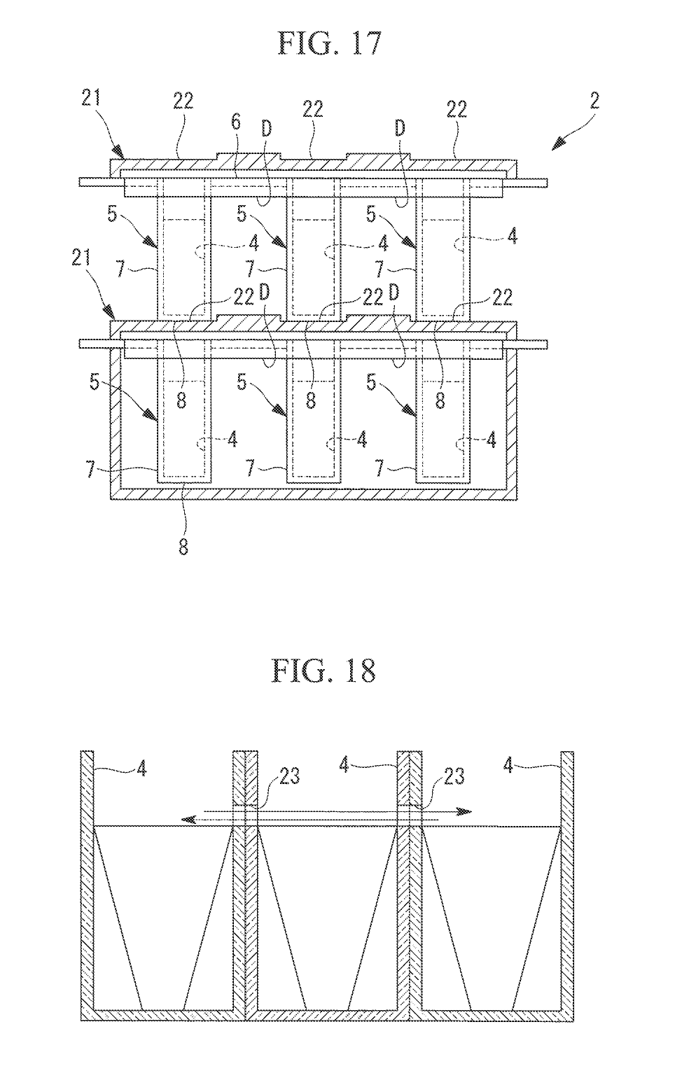

In addition, as shown in FIG. 17, a covering member 21 for covering the openings of the microplate 2 so as to close the openings may be provided, and the covering member 21 may be provided with recessed sections 22 each having a shape complementary with the shape of each of the bottom surface sections 8 of the microplate 2. By doing so, in a case where the microplates 2 are stored in a manner stacked one on another, as shown in FIG. 17, the bottom surface sections 8 may be stacked on the recessed sections 22 in a state where they are fitted with each other so as not to shift from each other.

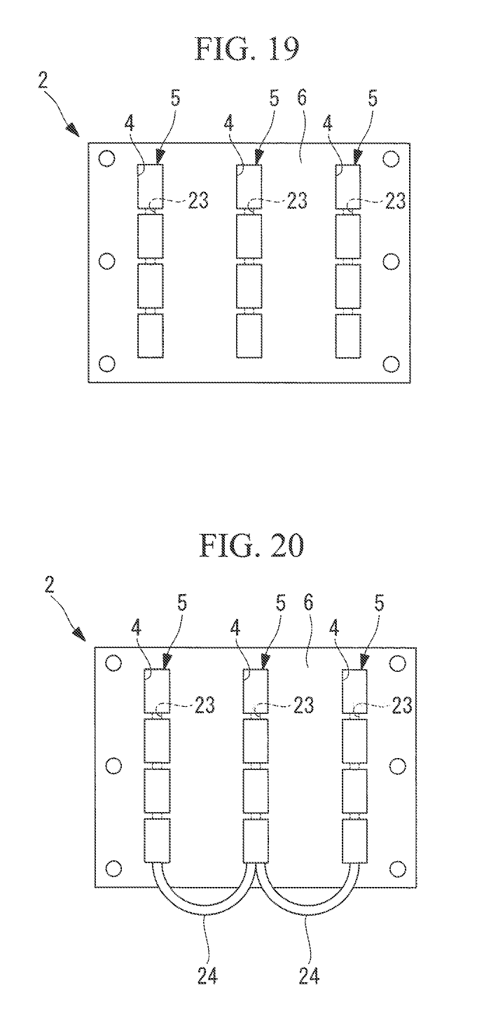

In addition, flow channels 23 connecting between neighboring wells 4 of the plurality of wells 4 arrayed in one row may be provided as shown in, FIGS. 18 and 19. This allows the media stored in the wells 4 to flow to the flow channels 23, thereby making it possible to homogenize the media in the wells 4. In a case where the media are, for example, culture media, the amount of oxygen or nutrients contained in the culture media can be homogenized. In this case, pipes 24 for circulating the media may also be provided for the wells 4 in the other rows, as shown in FIG. 20.

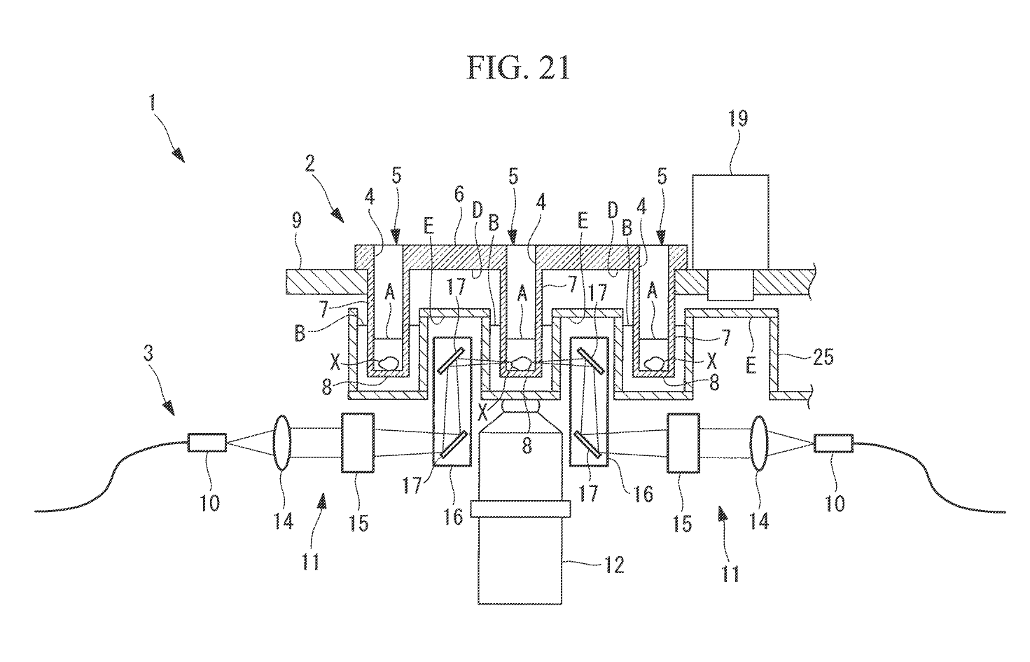

In addition, as shown in FIG. 21, the microscope system 1 according to this embodiment may include a medium container 25 for accommodating the microplate 2, and the objective lens 12 may be an immersion objective lens that can hold a liquid immersion medium between itself and the bottom surface of the medium container 25. The medium container 25 is provided with recessed sections E that allow an optical member to be inserted thereinto from therebelow.

In this case, a second medium B having an index of refraction equivalent to that of a first medium A stored in the wells 4 of the microplate 2 is stored in the medium container 25, and the microplate 2 is disposed such that the side wall sections 7 and the bottom surface sections 8, which transmit excitation light and light from the sample, are immersed into the second medium B.

The medium container 25 is disposed at a set position in the horizontal direction relative to the objective lens 12 and the optical members 16.

In addition, the outer periphery of the microplate 2 may be subjected to hydrophobic surface treatment so that the media do not adhere to the outer periphery of the microplate 2 when the microplate 2 is extracted from the medium container 25 after image acquisition is finished.

Employing the immersion objective lens allows an increase in the NA of fluorescence to be collected, thereby making it possible to acquire a high-resolution fluorescence image. In addition, by disposing the medium container 25 at a set position in the horizontal direction relative to the objective lens 12, even when the microplate 2 is horizontally swiveled in order to change the observed sample X, it is not necessary to relatively move the medium container 25 and the objective lens 12, thereby making it possible to reliably hold the liquid immersion medium.

In addition, there is an advantage in that because the first medium A stored in the wells 4 and the second medium B stored in the medium container 25 are formed of media having the same index of refraction, even when the proportion between the first medium A and the second medium B disposed in a direction along the optical axis of the objective lens 12 is changed as a result of moving the microplate 2 up/down through the operation of the movable stage 9, it is not necessary to change the focal plane of the objective lens 12.

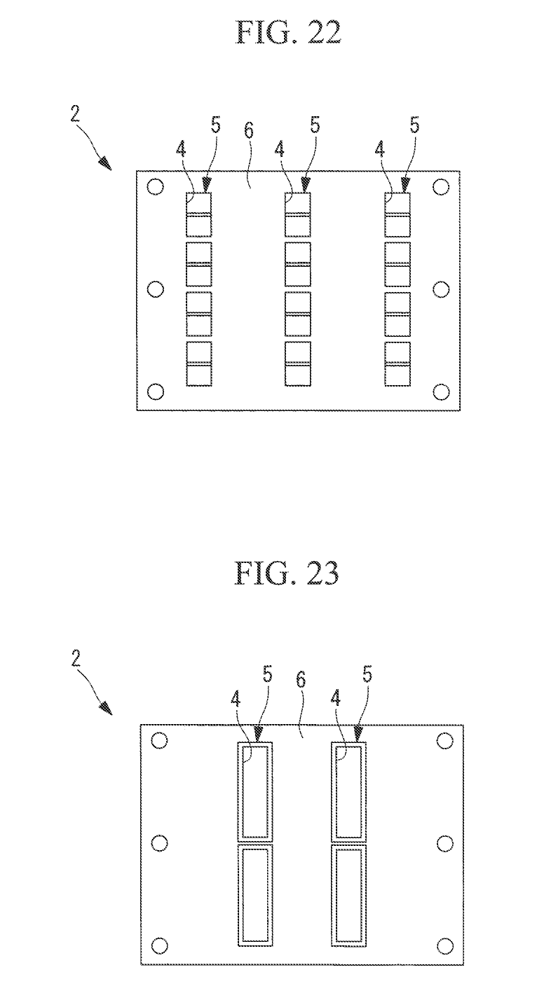

In addition, although this embodiment has been described by way of an example of the microplate 2 having a plurality of wells 4 arrayed in a ring shape about the central axis and that are also arranged in a plurality of rows in a manner spaced apart from each other in the radial direction, this embodiment may be configured of a microplate formed by arraying a plurality of rows in a square shape. As shown in FIGS. 22 and 23, the number of wells 4 in one row and the number of rows of the container sections 5 are not limited but may be any number.

The inventors have arrived at the following aspects of the present invention.

An aspect of the present invention provides a microplate including: a plurality of container sections having wells that open at a first plane and that accommodate samples; and a connection section connecting a plurality of rows of the container sections so as to be arrayed in a manner in which the rows are spaced from each other in a direction along the first plane, wherein each of the container sections includes: at least one side wall section that is optically transparent at at least a portion thereof; and a bottom surface section that is disposed on a second plane on a side opposite from the first plane and that is optically transparent at at least a portion thereof, and wherein a recessed section is formed between neighboring rows of the container sections, and the recessed section allows an optical member to be inserted thereinto crossing the second plane, wherein the said optical member introduces sheet-shaped illumination light into the well via the side wall section in a direction substantially parallel to the first plane.

According to this aspect, the microplate is disposed with the first plane oriented upward, and each of the plurality of wells that open in the first plane accommodates a sample. In this state, the optical member is inserted into the recessed section formed between neighboring rows of the container sections from the second plane side, which is a lower side disposed on the opposite side from the first plane. Thereafter, by causing the optical member to introduce, substantially parallel to the first plane, sheet-shaped illumination light to the side wall section of the container section, the illumination light that has passed through the optically transparent portion of the side wall section is radiated onto the sample in the well. On the other hand, part of the light generated in the sample passes through the optically transparent portion of the bottom surface and then can be detected below the bottom surface.

In this case, because the optical member is inserted between the container sections from the bottom surface side, instead of inserting the optical member from above into the well, the optical member can be disposed sufficiently upward relative to the bottom surface of the well, thereby making it possible to observe even a sample located on the bottom surface. In addition, the samples in the plurality of container sections can be efficiently observed merely by relatively moving the optical member and the microplate in a direction along the rows of the container sections.

In the above-described aspect, the side wall section may be disposed orthogonally to the bottom surface section.

By doing so, the illumination light can be introduced in a direction orthogonal to the side wall section, thereby making it possible to prevent refraction of the illumination light at the side wall section.

In addition, in the above-described aspect, each of the container sections may have two of the side wall sections disposed parallel to each other with the well interposed therebetween.

By doing so, the illumination light can be introduced via the two side wall sections, and thereby high-intensity illumination light can be radiated evenly across the whole of a relatively large sample by introducing the illumination light from both sides in a horizontal direction of the sample in the well.

In addition, in the above-described aspect, the side wall sections of the container sections in each of the rows may be formed of a single continuous member.

In addition, in the above-described aspect, the bottom surface sections of the container sections in each of the rows may be formed of a single continuous member.

In addition, in the above-described aspect, the container sections may be formed of a material different from that of the connection section.

In addition, in the above-described aspect, the side wall sections may be formed of a material different from that of the connection sections.

In addition, in the above-described aspect, the bottom surface sections may be formed of a material different from that of the connection section.

The side wall sections and the bottom surface sections of the container sections are required to have characteristics such that they transmit illumination light or light from the samples, and hence there is no choice but to use a relatively costly material; therefore, by forming them of a material different from that of the connection section, the microplate can be configured less costly.

In addition, in the above-described aspect, the side wall section and the bottom surface section of each of the container sections may be formed of a single moldable material.

By doing so, the side wall section and the bottom surface section, which are required to have light-transmitting characteristics, can be easily configured by molding.

In addition, in the above-described aspect, the container sections in each of the rows may be detachably attached to the connection section.

By doing so, the microplate can be configured such that the container sections, which are required to have light-transmitting characteristics, are manufactured independently of, and then combined with, the connection section.

In addition, in the above-described aspect, the container sections may be arrayed in a ring shape about a predetermined axial line and may be disposed in a plurality of rows in a manner where the rows are spaced from each other in a radial direction.

By doing so, the samples in different container sections can be successively irradiated with illumination light by horizontally swiveling the microplate about the predetermined axial in a state where the optical member is disposed at a position that allows illumination light to be introduced to the side wall section of one of the container sections, thereby allowing efficient observation.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

According to this aspect, samples are accommodated in a plurality of wells that open in the first plane, and the microplate is placed on the movable stage of the microscope with the openings oriented upward. In this state, the optical member is inserted into the recessed section formed between neighboring rows of the container sections and from a lower side of the microplate.

Thereafter, the sheet-shaped illumination light, which is formed by causing the optical member to introduce illumination light generated by the light source from below the microplate and to bend the illumination light, is made incident on the side wall section of the container section substantially horizontally and is thereby radiated onto the sample in the well after passing through the optically transparent portion of the side wall section. On the other hand, part of the light generated in the sample passes through the optically transparent portion of the bottom surface, is collected by the objective lens disposed below the bottom surface, and is imaged by the image acquisition unit.

An image spanning a wide area of the sample can be acquired all at once by causing the focal position of the objective lens to be aligned with the incident plane of the sheet-shaped illumination light.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; two of the optical members that are inserted from a lower side into the recessed sections formed between the neighboring rows of the container sections of the microplate, that introduce illumination light from light sources and from a lower side of the microplate, and that bend the illumination light to enter the well via the two side wall sections as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

According to this aspect, illumination light can be introduced via the two side wall sections, and high-intensity illumination light can be evenly radiated across the whole of a relatively large sample by introducing the illumination light from both sides of the sample in the well along the horizontal direction.

In addition, another aspect of the present invention provides a microscope system including: the above-described microplate; and a microscope which acquires an observation image of the sample accommodated in the well of the microplate, wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens, and wherein the movable stage rotates the microplate about the axial line.

According to this aspect, the samples in different container sections can be sequentially irradiated with illumination light to perform efficient observation by horizontally swiveling the microplate about the predetermined axial line through the operation of the movable stage in a state where the optical member is disposed at a position that allows the illumination light to enter the side wall section of one of the container sections.

In the above-described aspect, a first medium into which the samples are immersed may be stored in the wells, a medium container that stores a second medium into which at least portions of the side wall sections and the bottom surface sections of the microplate are immersed and which has a recessed section formed between the neighboring rows of the container sections of the microplate such that the optical member can be inserted into the recessed section from a lower side may be provided, and a refraction index of the first medium is substantially equivalent to a refraction index of the second medium.

By doing so, even if the proportion between the first medium and the second medium disposed between the incident plane of the sheet-shaped illumination light and the objective lens is changed as a result of the microplate being moved in the medium container, the state in which the focal position of the objective lens is aligned with the incident plane of the illumination light can be maintained. In addition, observation with a high-resolution image can be performed by employing an immersion objective lens as the objective lens.

The above-described aspect affords an advantage in that not only is it possible to observe a sample located on the bottom surface, but also, a plurality of samples can be efficiently observed.

### REFERENCE SIGNS LIST

1 Microscope system
2 Microplate
3 Microscope
4 Well
5 Container section
6 Connection section
7 Side wall section
8 Bottom surface section
9 Movable stage
12 Objective lens
13 Image acquisition element (image acquisition unit)
16 Optical member
25 Medium container
A First medium
B Second medium
D Recessed section
E Recessed section
X Sample

1. A microplate comprising:
a plurality of container sections having wells that open at a first plane and that accommodate samples; and
a connection section connecting a plurality of rows of the container sections so as to be arrayed in a manner in which the rows are spaced from each other in a direction along the first plane,
wherein each of the container sections includes: at least one side wall section that is optically transparent at at least a portion thereof; and a bottom surface section that is disposed on a second plane on a side opposite from the first plane and that is optically transparent at at least a portion thereof, and
wherein a recessed section is formed between neighboring rows of the container sections, and the recessed section allows an optical member to be inserted thereinto crossing the second plane, wherein the said optical member introduces sheet-shaped illumination light into the well via the side wall section in a direction substantially parallel to the first plane.

2. The microplate according to claim 1, wherein the side wall section is disposed orthogonally to the bottom surface section.

3. The microplate according to claim 2, wherein each of the container sections has two of the side wall sections disposed parallel to each other with the well interposed therebetween.

4. The microplate according to claim 1, wherein the side wall sections of the container sections in each of the rows are formed of a single continuous member.

5. The microplate according to claim 1, wherein the bottom surface sections of the container sections in each of the rows are formed of a single continuous member.

6. The microplate according to claim 1, wherein the container sections are formed of a material different from that of the connection section.

7. The microplate according to claim 1, wherein the side wall sections are formed of a material different from that of the connection sections.

8. The microplate according to claim 1, wherein the bottom surface sections are formed of a material different from that of the connection section.

9. The microplate according to claim 1, wherein the side wall section and the bottom surface section of each of the container sections are formed of a single moldable material.

10. The microplate according to claim 1, wherein the container sections in each of the rows are detachably attached to the connection section.

11. The microplate according to claim 1, wherein the container sections are arrayed in a ring shape about a predetermined axial line and are disposed in a plurality of rows in a manner where the rows are spaced from each other in a radial direction.

12. A microscope system comprising:
the microplate according to claim 1; and
a microscope which acquires an observation image of the sample accommodated in the well of the microplate,
wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

13. A microscope system comprising:
the microplate according to claim 3; and
a microscope which acquires an observation image of the sample accommodated in the well of the microplate,
wherein the microscope includes: a movable stage which supports the microplate so as to be movable at least in a horizontal direction; two of the optical members that are inserted from a lower side into the recessed sections formed between the neighboring rows of the container sections of the microplate, that introduce illumination light from light sources and from a lower side of the microplate, and that bend the illumination light to enter the well via the two side wall sections as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens.

14. A microscope system comprising:
the microplate according to claim 11; and
a microscope which acquires an observation image of the sample accommodated in the well of the microplate,
wherein the microscope includes: a movable stage which supports the microplate so as to be movable at least in a horizontal direction; the optical member that is inserted from a lower side into the recessed section formed between the neighboring rows of the container sections of the microplate, that introduces illumination light coming from a light source and from a lower side of the microplate, and that bends the illumination light to enter the well via the side wall section as the sheet-shaped illumination light extending in a horizontal direction; an objective lens that collects, via the bottom surface section, light generated in the sample as a result of being irradiated with the illumination light; and an image acquisition unit which acquires an image of the light collected by the objective lens, and
wherein the movable stage rotates the microplate about the axial line.

15. The microscope system according to claim 12,
wherein a first medium into which the samples are immersed is stored in the wells,
a medium container that stores a second medium into which at least portions of the side wall sections and the bottom surface sections of the microplate are immersed and which has a recessed section formed between the neighboring rows of the container sections of the microplate such that the optical member can be inserted into the recessed section from a lower side is provided, and
a refraction index of the first medium is substantially equivalent to a refraction index of the second medium.
